(19) United States
(12) Patent Application Publication
(10) Pub. No.: US 2015/0358215 A1
(43) Pub. Date: Dec. 10, 2015

(54) SHARED RISK INFLUENCE EVALUATION SYSTEM, SHARED RISK INFLUENCE EVALUATION METHOD, AND PROGRAM

(71) Applicant: NEC Corporation, Tokyo (JP)

(72) Inventor: Yoshiharu MAENO, Tokyo (JP)

(21) Appl. No.: 14/410,158

(22) PCT Filed: Mar. 28, 2013
(86) PCT No.: PCT/JP2013/059258

§ 371 Date: Dec. 22, 2014

(30) Foreign Application Priority Data
Jun. 29, 2012 (JP) 2012-146691

(51) Int. Cl. H04L 12/24; H04L 29/08

(52) U.S. Cl. CPC H04L 41/5048; H04L 67/16

(57) ABSTRACT

An object of the present invention is to make it possible to analyze a shared risk that is the most important in view of the influence on a service. Provided is a shared risk influence evaluation system including: a shared risk management section for managing, for each shared risk factor on the system, information of a device and an application to be influenced by the shared risk factor; a device characteristic management section for managing information regarding characteristics of the device and the application; a service characteristic management section for, for each service provided by the system, managing information of an application needed for providing the service; and an influence calculation section for calculating an influence on the system for each shared risk factor based on the information of a device and an application to be influenced by the shared risk factor and the information of an application needed for providing the service.

### BACKGROUND

The present invention relates to a shared risk influence evaluation system, a shared risk influence evaluation method, and a program.

In an information system service where applications running on virtual servers and physical servers at cloud data centers are provided on-line to many tenant corporations, the availability of a system is analyzed by using an availability prediction model based on a mathematic approach so as to assist in risk management and design improvements.

Patent Document 1 describes an information processing device including: storage means storing therein component information regarding components for forming a system having a predetermined function; and processing means for calculating, based on the component information, combinations of components necessary for forming a system requested by a service, calculating risk information, which is information of a risk of a physical trouble on the service request for these combinations of components, and fragment information, which is information of the degree of imbalance in usage between components, and prioritizing the selected component combinations based on a predetermined policy and the calculated risk information and fragment information. Thus, in a system having a plurality of services, the burden on the administrator responsible for service management is reduced, and even when the settings are changed due to a system update, or the like, it is possible to do the settings without being aware of the change in the service settings.

Patent Document 2 discloses an information system reliability evaluation system for analyzing failure information for failure modes of components representing software and hardware, and calculating the system capacity utilization based on the failure analysis information and operation process analysis information.

Patent Document 1: WO 2006-54573

Patent Document 2: Patent Publication JP-A-2007-122639

However, with the methods described in Patent Documents 1 and 2, it was not possible to analyze shared risks that influence individual services based on the characteristics of devices and applications involved in the provision of the services, and to make an overall judgment on the magnitude of the influence of the shared risk factors.

### SUMMARY

Thus, it is an exemplary object of the present invention to make it possible to analyze a shared risk that is the most important in view of the influence on the service.

A shared risk influence evaluation system according to the present invention includes: a shared risk management section for managing, for each shared risk factor on the system, information of a device and an application to be influenced by the shared risk factor; a device characteristic management section for managing information regarding characteristics of the device and the application; a service characteristic management section for, for each service provided by the system, managing information of an application needed for providing the service; and an influence calculation section for calculating an influence on the system for each shared risk factor based on the information of a device and an application to be influenced by the shared risk factor and the information of an application needed for providing the service.

A shared risk influence evaluation method according to the present invention includes: obtaining, for each shared risk factor on a system, information of a device and an application to be influenced by the shared risk factor; obtaining information regarding characteristics of the device and the application; obtaining, for each service provided by the system, information of an application needed for providing the service; and calculating an influence on the system for each shared risk factor based on the information of a device and an application to be influenced by the shared risk factor and the information of an application needed for providing the service.

A program according to the present invention causes a computer to function as: a shared risk management section for managing, for each shared risk factor on the system, information of a device and an application to be influenced by the shared risk factor; a device characteristic management section for managing information regarding characteristics of the device and the application; a service characteristic management section for, for each service provided by the system, managing information of an application needed for providing the service; and an influence calculation section for calculating an influence on the system for each shared risk factor based on the information of a device and an application to be influenced by the shared risk factor and the information of an application needed for providing the service.

According to an exemplary aspect of the present invention, it is made possible to analyze a shared risk that is the most important in view of the influence on the service.

### DESCRIPTION OF DRAWINGS

FIG. 1 is a block diagram showing a configuration of a shared risk influence evaluation system according to an embodiment of the present invention.

FIG. 2 is a diagram showing an example of a shared risk management table according to an embodiment of the present invention.

FIG. 3 is a diagram showing an example of a device characteristic management table according to an embodiment of the present invention.

FIG. 4 is a diagram showing an example of a service characteristic management table according to an embodiment of the present invention.

FIG. 5 is a flow chart of an operation of a shared risk influence evaluation system according to an embodiment of the present invention.

FIG. 6 is a diagram showing an example configuration of an information system to be analyzed according to an embodiment of the present invention.

FIG. 7 is a graph schematically showing the relationship between physical servers, virtual servers, applications and services of an information system to be analyzed according to an embodiment of the present invention.

FIG. 8 shows results of calculating the application influence for all the applications for each physical server and virtual server, which are shared risk factors, according to an embodiment of the present invention.

FIG. 9 shows results of calculating the service influence on all the services for each physical server and virtual server, which are shared risk factors, and the influence for each risk factor, according to an embodiment of the present invention.

FIG. 10 shows the results of calculating the service and the application to be most influenced by each shared risk factor according to an embodiment of the present invention.

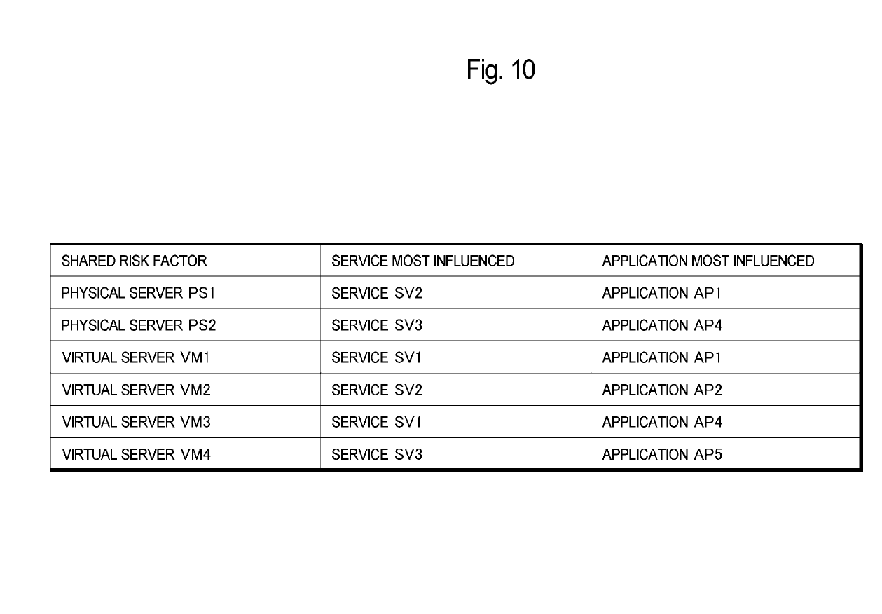

### EXEMPLARY EMBODIMENT

Next, embodiments for carrying out the present invention will be described in detail with reference to the drawings.

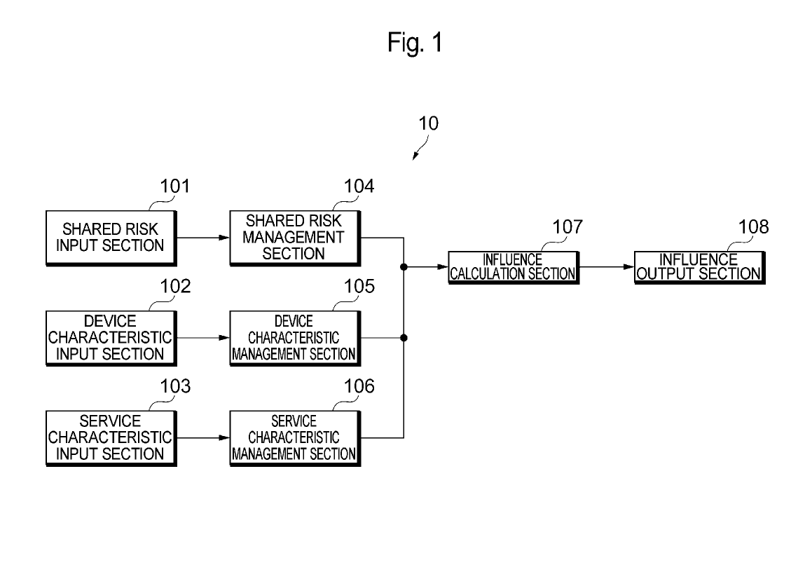

FIG. 1 is a block diagram showing a configuration of a shared risk influence evaluation system 10 according to an embodiment of the present invention. As shown in the figure, the shared risk influence evaluation system 10 includes a shared risk input section 101, a device characteristic input section 102, a service characteristic input section 103, a shared risk management section 104, a device characteristic management section 105, a service characteristic management section 106, an influence calculation section 107, and an influence output section 108.

The shared risk influence evaluation system 10 may be a dedicated or general-purpose computer including a CPU, memories such as a ROM, a RAM, and the like, an external storage device for storing various information, an input interface, an output interface, a communication interface, and buses connecting them together. Note that the shared risk influence evaluation system 10 may be formed by a single computer, or a plurality of computers connected together via a communication line.

The shared risk input section 101, the device characteristic input section 102, the service characteristic input section 103, the influence calculation section 107, and the influence output section 108 correspond to modules of the functions implemented by the CPU executing a predetermined program stored in a ROM, or the like. The shared risk management section 104, the device characteristic management section 105 and the service characteristic management section 106 are implemented by an external storage device.

The shared risk input section 101 is an interface for inputting data to a shared risk management table carried by the shared risk management section 104.

The shared risk input section 101 may read data via a network, or the system administrator may input data from a keyboard.

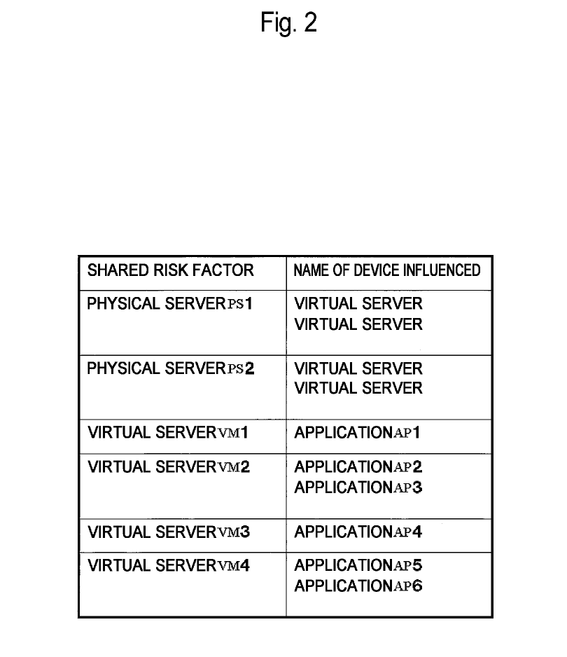

The shared risk management section 104 carries a shared risk management table which includes a row for each risk factor, and which, as its items, has “Shared Risk Factor” and “Name of Device Influenced” by the shared risk factor (identifiers of devices). FIG. 2 shows an example of a shared risk management table. The “Name of Device Influenced” includes all physical servers, virtual servers and applications influenced by the failure of the shared risk factors (devices).

The shared risk management table may be carried as a relational database table, or may be carried in a text form in a file. The administrator of the information system can add new items as necessary via the shared risk input section 101 to the shared risk management table, or delete or modify items which have already been registered.

The device characteristic input section 102 is an interface for inputting information to the device characteristic management table carried by the device characteristic management section 105. The device characteristic input section 102 may read data via a network, or the system administrator may input data from a keyboard.

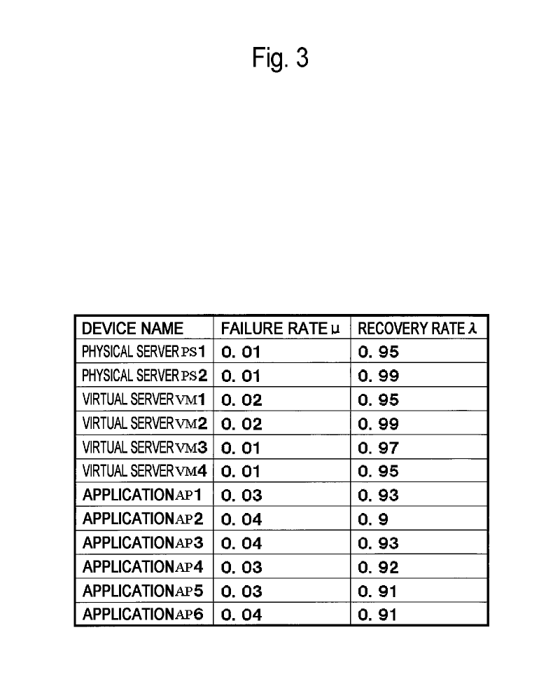

The device characteristic management section 105 carries a device characteristic management table which includes a row for each physical server, virtual server and application, and which, as its items, has “Device Name” (identifiers of physical servers, virtual servers and applications), “Failure Rate μ” of devices, and “Recovery Rate λ,” of devices. The failure rate μ and the recovery rate λ, are each a real number from 0 to 1. These values are the same values as those used for the state transition rate of the availability prediction model based on the stochastic Petri net. FIG. 3 shows an example of the device characteristic management table.

The administrator of the information system can add new items as necessary via the device characteristic input section 102 to the device characteristic management table, or delete or modify items which have already been registered.

The service characteristic input section 103 is an interface for inputting information to the service characteristic management table carried by the service characteristic management section 106. The service characteristic input section 103 may read data via a network, or the system administrator may input data from a keyboard.

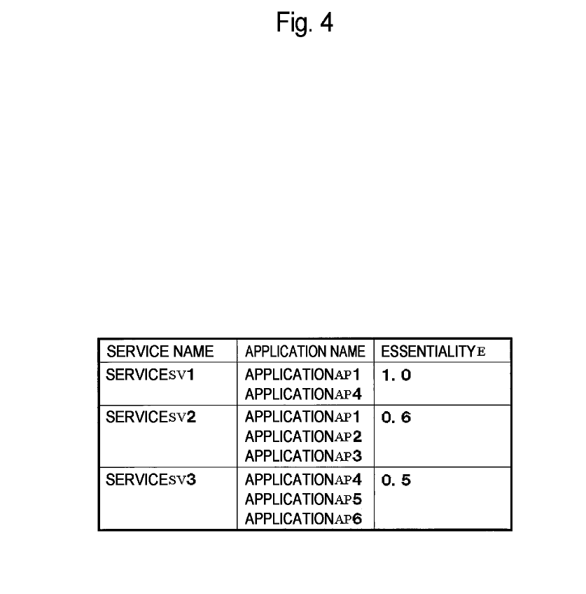

The service characteristic management section 106 carries a service characteristic management table which includes a row for each service, and which, as its items, has “Service Name” (identifiers of services), “Application Name” of applications (identifiers of applications) forming a service which are necessary for the provision of the service, and “Essentiality E” representing the degree of importance of the service from the user's point of view. FIG. 4 shows an example of the service characteristic management table.

The “Essentiality E” is a real number from 0 to 1. The essentiality “1” indicates a service that is the most important for the user. A smaller essentiality means that it is a service less important for the user, and the service can be discontinued due to a trouble, or the like, if it is unavoidable. The administrator of the information system can add new items as necessary via the service characteristic input section 103 to the service characteristic management table, or delete or modify items which have already been registered.

The influence calculation section 107 calculates the magnitude of the influence for each shared risk factor, and outputs it to the influence output section 108, based on the shared risk management table carried by the shared risk management section 104, the device characteristic management table carried by the device characteristic management section 105, and the service characteristic management table carried by the service characteristic management section 106.

The influence output section 108 is an interface for outputting the influence for each shared risk factor calculated by the influence calculation section 107. The influence output section 108 may output the influence via a network, or may display the influence on the display.

Next, an operation of the shared risk influence evaluation system 10 will be described.

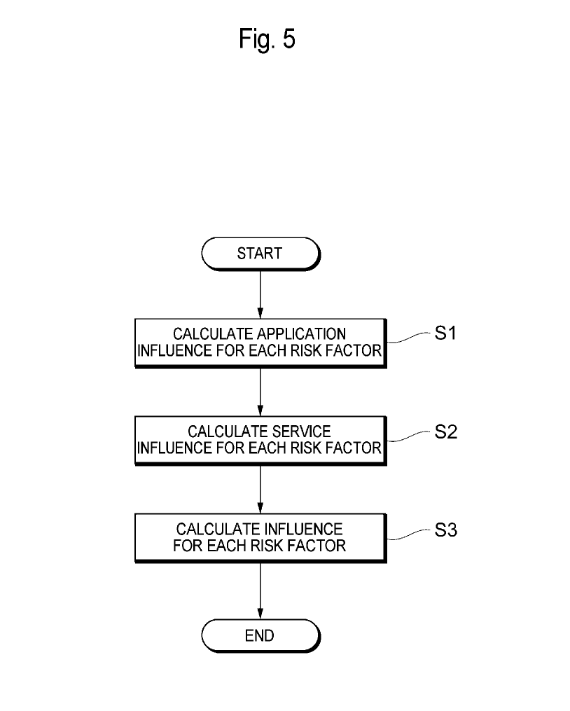

FIG. 5 is a flow chart of an operation of the shared risk influence evaluation system 10.

First, the influence calculation section 107 calculates, for each shared risk factor, the application influence for all applications based on the shared risk management table and the device characteristic management table (step S1).

Specifically, the application influence for an application APk of a physical server Si, which is a shared risk factor, is calculated by the following expression.

Application Influence (Si→*APk)=1/μ_{Si}+1/μ_{VMj}+1/μ_{APk} [Expression 1]

Here, the application APk runs on a virtual server VMj, and the virtual server VMj runs on the physical server Si. By referencing the shared risk management table, the influence calculation section 107 can obtain the identifier of a virtual server VMj, given a physical server Si and an application APk. Where the virtual server VMj, on which the application APk is running, is not running on the physical server Si, the value of the application influence is 0. By referencing the device characteristic management table, the influence calculation section 107 can obtain the value of the failure rateμ of the physical server Si, the virtual server VMj and the application APk.

Moreover, the influence calculation section 107 calculates the application influence for the application APk of the virtual server VMj, which is a shared risk factor, by the following expression.

Application Influence (VMj→*APk)=1/μ_{VMj}+1/μ_{APk} [Expression 2]

Now, where the application APk is not running on the virtual server VMj, the value of the application influence is 0. By referencing the device characteristic management table, the influence calculation section 107 can obtain the value of the failure rateμ of the virtual server VMj and the application APk.

Next, the influence calculation section 107 calculates the service influence for all services for each risk factor based on the application influence for each risk factor calculated in step S1 and the service characteristic management table (step S2).

Specifically, the service influence for the service SVI of the physical server Si, which is a shared risk factor, is calculated by the following expression.

Service Influence (Si→SVI)=Σ Application Influence (Si→*APk){all applications APk used by SVI} [Expression 3]

The influence calculation section 107 adds up the application influences of all the applications needed for providing the service SVI. By referencing the service characteristic management table, the influence calculation section 107 can obtain the applications needed for providing the service SVI.

Next, the influence calculation section 107 calculates the influence for each risk factor by using the following expression (step S3).

Influence (Si)=Σ Service Influence (Si→SVI)×Essentiality E_{SVI} {all services SVI} [Expression 4]

The influence for each risk factor is what is obtained by adding up the service influences calculated in step S2 while using the essentialities E of the services SVI as weights. By referencing the service characteristic management table, the influence calculation section 107 can obtain the essentiality of the service SVI.

As described above, according to the present embodiment, the influence of a risk factor is calculated while taking into consideration the risk factor, the characteristic (failure rate) of the device and the application to be influenced by the risk factor, and the importance of the service, and it is therefore possible to analyze a shared risk that is the most important in view of the influence on the service.

### EMBODIMENTS

Embodiments of the present invention will be described in detail with reference to the drawings.

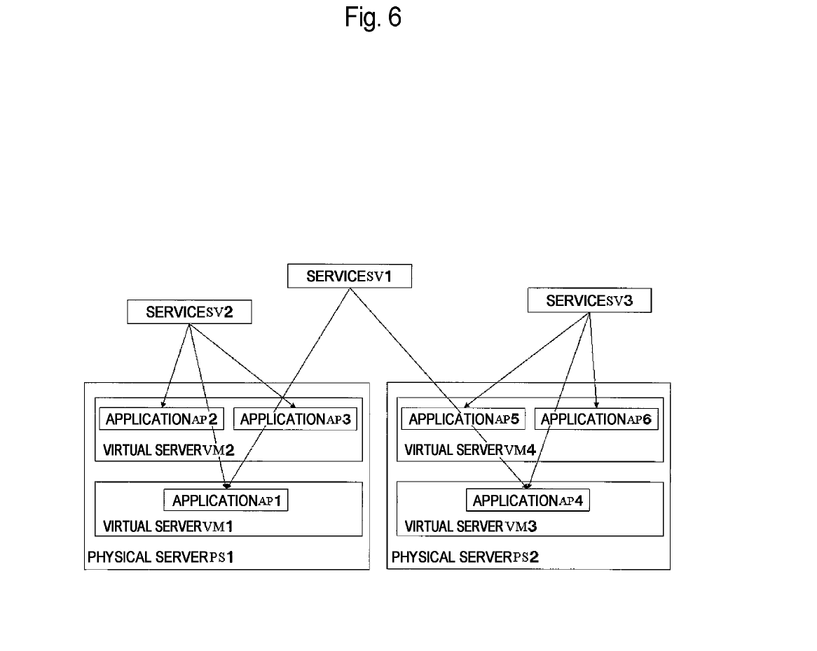

FIG. 6 shows an example configuration of an information system to be analyzed. As shown in the figure, since a virtual server VM1 and a virtual server VM2 run on a physical server PS1, a trouble of the physical server PS1 influences the operation of the virtual server VM1 and the virtual server VM2. That is, the physical server PS1 is a shared risk factor for the virtual server VM1 and the virtual server VM2.

An application AP1 runs on the virtual server VM1, and an application AP2 and an application AP3 run on the virtual server VM2. That is, the virtual server VM1 is a shared risk factor for the application AP1. The virtual server VM2 is a shared risk factor for the application AP2 and the application AP3.

Since a virtual server VM3 and a virtual server VM4 run on a physical server PS2, a trouble of the physical server PS2 influences the operation of the virtual server VM3 and the virtual server VM4. That is, the physical server PS2 is a shared risk factor for the virtual server VM3 and the virtual server VM4. An application AP4 runs on the virtual server VM3, and an application AP5 and an application AP6 run on the virtual server VM4. That is, the virtual server VM3 is a shared risk factor for the application AP4. The virtual server VM4 is a shared risk factor for the application AP5 and the application AP6.

The shared risk management table, the device characteristic management table and the service characteristic management table of the information system shown in FIG. 6 are shown in FIG. 2, FIG. 3 and FIG. 4, respectively. That is, the failure rate of the physical server PS1 is μ_{PS1}=0.01, the recovery rate thereof is λ_{PS1}1=0.95. The failure rate of the virtual server VM1 is μ_{VM1}=0.02, and the recovery rate thereof is λ_{VM1}=0.95. The failure rate of the application AP1 is μ_{AP1}=0.03, and the recovery rate thereof is λ_{AP1}=0.93.

As shown in FIG. 4, the applications needed for providing a service SV1 are the application AP1 and the application AP4. The applications needed for providing a service SV2 are the application AP1, the application AP2 and the application AP3. The applications forming the service needed for providing a service SV3 are the application AP4, the application AP5 and the application AP6. The essentiality of the service SV1 is E_{SV1}=1.0, the essentiality of the service SV2 is E_{SV2}=0.6, and the essentiality of the service SV3 is E_{SV3}=0.5.

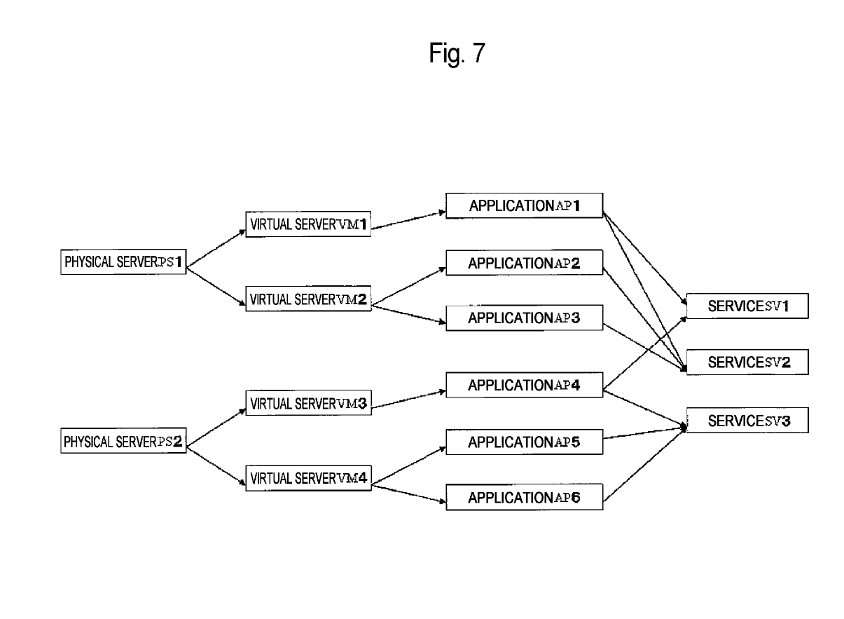

FIG. 7 is a graph schematically showing the relationship between physical servers, virtual servers, applications and services of the information system shown in FIG. 6.

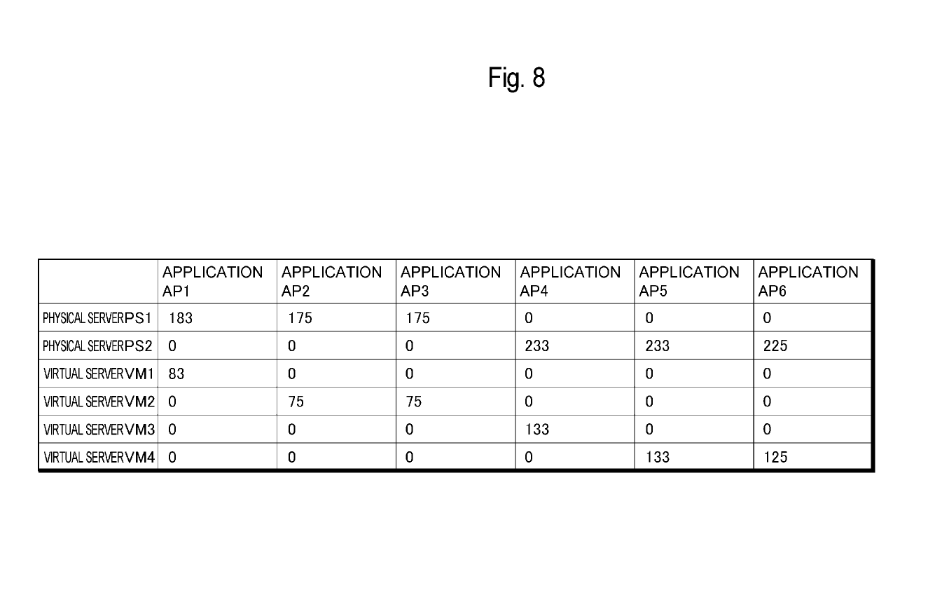

FIG. 8 shows the results of calculating the application influence for all the applications for each physical server and virtual server, which are shared risk factors. As shown in the figure, the influence of the physical server PS1 on the application AP1 is 183, the influence thereof on the application AP2 is 175, the influence thereof on the application AP3 is 175, and the influence on the other applications is 0.

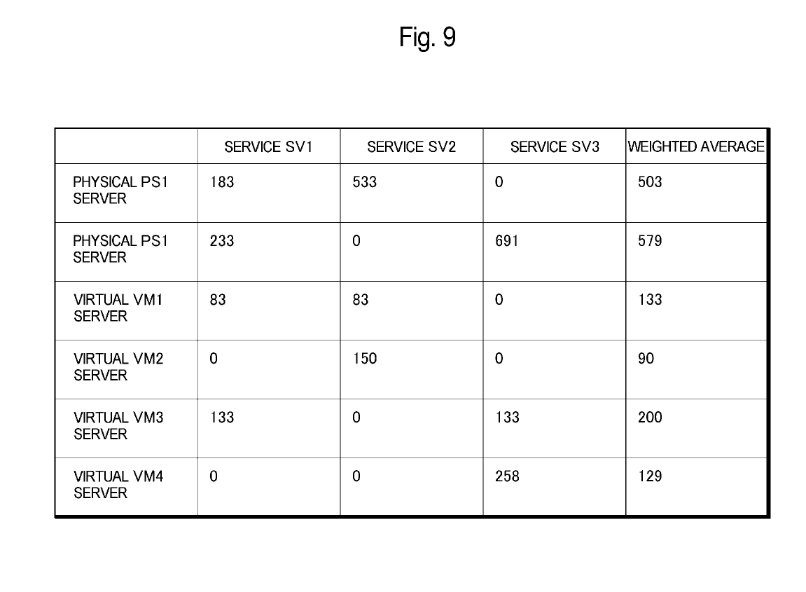

FIG. 9 shows the results of calculating the service influence on all the services for each physical server and virtual server, which are shared risk factors, and the influence (weighted average) for each risk factor. The influence of the physical server PS1 on the service SV1 is 183, the influence thereof on the service SV2 is 533, and the influence thereof on the service SV3 is 0. The influence of the physical server PS1 is 503. The influence of the physical server PS2 is 579. The influence of the virtual server VM1 is 133. The influence of the virtual server VM2 is 90. The influence of the virtual server VM3 is 200. The influence of the virtual server VM4 is 129.

Moreover, it is possible to obtain the influence for each shared risk factor by calculating the average influence weighted with essentialities of the services. As shown in FIG. 9, the shared risk factor with the greatest influence is the physical server PS2 (579). The shared risk factor with the greatest influence among the virtual servers is the virtual server VM3 (200). From this result, it can be seen that it is necessary to improve the design so as to reduce the influence of a failure of the physical server PS2 and the virtual server VM3.

### Embodiment 2

In Embodiment 2, when the influence calculation section 107 calculates the application influence for each application for each shared risk factor, not only the failure rates μ of the physical server Si, the virtual server VMj and the application APk, but also the recovery rate λ included in the device characteristic management table are used. Specifically, the application influence of the physical server Si on the application APk is calculated by the following expression.

Application Influence (Si→*APk)=1/μ_{Si}+1/μ_{VMj}+1/μ_{APk} +1/λ_{Si}+1/λ_{VMj}+1/λ_{APk} [Expression 5]

The application influence of the virtual server VMj on the application APk can be similarly calculated by using the recovery rate λ.

Moreover, when the influence calculation section 107 calculates the influence for each shared risk factor, the maximum value of the service influence may be selected instead of adding up the service influences weighted with the essentialities of the services SVI. That is, the influence for each risk factor is calculated by the following expression.

Service Influence (Si→SVI)=max Application Influence (Si→*APk) {all applications APk used by SVI} [Expression 6]

An average influence among risk factors is obtained in Embodiment 1, whereas an influence taking the worst influence into consideration is obtained in Embodiment 2.

Not only the influence for each shared risk factor, but also the name of the service to be most influenced by each shared risk factor and the name of the application to be most influenced by each shared risk factor may be output from the influence output section 107.

The service to be most influenced by each shared risk factor can be obtained by calculating the value of service influence×essentiality for each service and selecting the service for which the value is largest, referring to FIG. 9. For example, for the physical server PS1, the value of the service SV1 is 183×1.0, and the value of the service SV2 is 533×0.6, the value of the service SV1 is 0×0.5, and the service to be most influenced is the service SV2. Similarly, for the physical server PS2, the service to be most influenced is the service SV3. For the virtual server VM1, the service to be most influenced is the service SV1.

The application to be most influenced by each shared risk factor can be obtained by selecting the application for which the application influence is largest, referring to FIG. 8. For example, for the physical server PS1, the application to be most influenced is the application AP1. Similarly, it is the application AP4 for the physical server PS2, and it is the application AP1 for the virtual server VM1. FIG. 11 shows the results of calculating the service and the application to be most influenced by each shared risk factor.

Referring to FIG. 11, it can be seen that the greatest influence of a failure of the physical server PS1 as a shared risk factor is present in the service SV2, and it is through a trouble of the application AP1. Thus, it is possible to analyze how the influence of a failure propagates.

This application claims priority to Japanese Patent Application No. 2012-146691 filed on Jun. 29, 2012, the entire disclosure of which is incorporated herein by reference.

While the present invention has been described above with reference to the embodiments thereof, the present invention is not limited to the embodiments described above. As can be appreciated by a person of ordinary skill in the art, various changes can be made to the configurations and particulars of the present invention within the scope of the present invention.

Some or all of the embodiments described above can be defined as in the following appendices, but the present invention is not limited thereto.

### Appendix 1

A shared risk influence evaluation system comprising:

a shared risk management section for managing, for each shared risk factor on the system, information of a device and an application to be influenced by the shared risk factor;

a device characteristic management section for managing information regarding characteristics of the device and the application;

a service characteristic management section for, for each service provided by the system, managing information of an application needed for providing the service; and

an influence calculation section for calculating an influence on the system for each shared risk factor based on the information of a device and an application to be influenced by the shared risk factor and the information of an application needed for providing the service.

### Appendix 2

The shared risk influence evaluation system according to Appendix 1, wherein the influence calculation section:

calculates, for each application, an application influence to be given by each shared risk factor on the application;

calculates, for each service, a service influence which is a sum of the application influences of all applications needed for providing the service; and

calculates an influence on the system for each shared risk factor, based on the service influence.

### Appendix 3

The shared risk influence evaluation system according to Appendix 1 or 2, wherein:

the information of the device and the application to be influenced by the shared risk factor includes a failure rate of the device and the application; and

the influence calculation section calculates an application influence in such a manner that the application influence is greater as the failure rate of the device and the application to be influenced by each shared risk factor is smaller.

### Appendix 4

The shared risk influence evaluation system according to any one of Appendices 1 to 3, wherein:

the information of the device and the application to be influenced by the shared risk factor includes a recovery rate of the device and the application; and

the influence calculation section calculates an application influence in such a manner that the application influence is greater as the recovery rate of the device and the application to be influenced by each shared risk factor is smaller.

### Appendix 5

The shared risk influence evaluation system according to any one of Appendices 2 to 4, wherein:

the information of the application needed for providing the service includes an essentiality of the service from a users point of view; and

the influence calculation section uses, as the influence on the system for each shared risk factor, a value obtained by adding up the service influences weighted with the essentialities of the services.

### Appendix 6

The shared risk influence evaluation system according to any one of Appendices 2 to 4, wherein the influence calculation section uses, as the influence on the system for each shared risk factor, a maximum value among the service influences.

### Appendix 7

A shared risk influence evaluation method comprising:

obtaining, for each shared risk factor on a system, information of a device and an application to be influenced by the shared risk factor;

obtaining information regarding characteristics of the device and the application;

obtaining, for each service provided by the system, information of an application needed for providing the service; and

calculating an influence on the system for each shared risk factor based on the information of a device and an application to be influenced by the shared risk factor and the information of an application needed for providing the service.

### Appendix 8

A program causing a computer to function as:

a shared risk management section for managing, for each shared risk factor on the system, information of a device and an application to be influenced by the shared risk factor;

a device characteristic management section for managing information regarding characteristics of the device and the application;

a service characteristic management section for, for each service provided by the system, managing information of an application needed for providing the service; and

an influence calculation section for calculating an influence on the system for each shared risk factor based on the information of a device and an application to be influenced by the shared risk factor and the information of an application needed for providing the service.

The present invention is suitable for analyzing the availability of a system by using an availability prediction model based on a mathematic approach, in an information system service where applications running on virtual servers and physical servers at cloud data centers are provided on-line to many tenant corporations.

10: Shared risk influence evaluation system, 101: Shared risk input section, 102: Device characteristic input section, 103: Service characteristic input section, 104: Shared risk management section, 105: Device characteristic management section, 106: Service characteristic management section, 107: Influence calculation section, 108: Influence output section

1. A shared risk influence evaluation system comprising:
a shared risk management section for managing, for each shared risk factor on the system, information of a device and an application to be influenced by the shared risk factor;
a device characteristic management section for managing information regarding characteristics of the device and the application;
a service characteristic management section for, for each service provided by the system, managing information of an application needed for providing the service; and
an influence calculation section for calculating an influence on the system for each shared risk factor based on the information of a device and an application to be influenced by the shared risk factor and the information of an application needed for providing the service.

2. The shared risk influence evaluation system according to claim 1, wherein the influence calculation section:
calculates, for each application, an application influence to be given by each shared risk factor on the application;
calculates, for each service, a service influence, which is a sum of the application influences of all applications needed for providing the service; and
calculates an influence on the system for each shared risk factor, based on the service influence.

3. The shared risk influence evaluation system according to claim 1, wherein:
the information of the device and the application to be influenced by the shared risk factor includes a failure rate of the device and the application; and
the influence calculation section calculates an application influence in such a manner that the application influence is greater as the failure rate of the device and the application to be influenced by each shared risk factor smaller.

4. The shared risk influence evaluation system according to claim 1, wherein:
the information of the device and the application to be influenced by the shared risk factor includes a recovery rate of the device and the application; and
the influence calculation section calculates an application influence in such a manner that the application influence is greater as the recovery rate of the device and the application to be influenced by each shared risk factor is smaller.

5. The shared risk influence evaluation system according to claim 2, wherein:
the information of the application needed for providing the service includes an essentiality of the service from a user's point of view; and
the influence calculation section uses, as the influence on the system for each shared risk factor, a value obtained by adding up the service influences weighted with the essentialities of the services.

6. The shared risk influence evaluation system according to claim 2, wherein the influence calculation section uses, as the influence on the system for each shared risk factor, a maximum value among the service influences.

7. A shared risk influence evaluation method comprising:
obtaining, for each shared risk factor on a system, information of a device and an application to be influenced by the shared risk factor;
obtaining information regarding characteristics of the device and the application;
obtaining, for each service provided by the system, information of an application needed for providing the service; and
calculating an influence on the system for each shared risk factor based on the information of a device and an application to be influenced by the shared risk factor and the information of an application needed for providing the service.

8. A program causing a computer to function as:
a shared risk management section for managing, for each shared risk factor on the system, information of a device and an application to be influenced by the shared risk factor;
a device characteristic management section for managing information regarding characteristics of the device and the application;
a service characteristic management section for, for each service provided by the system, managing information of an application needed for providing the service; and
an influence calculation section for calculating an influence on the system for each shared risk factor based on the information of a device and an application to be influenced by the shared risk factor and the information of an application needed for providing the service.
